(19) United States
(12) Patent Application Publication
(10) Pub. No.: US 2007/0222668 A1
(43) Pub. Date: Sep. 27, 2007

(54) Wave Guide Adapter with Decoupling Member for Planar Wave Guide Couplings

(76) Inventors: Daniel Schultheiss, Hornberg (DE); Josef Fehrenbach, Haslach i.K. (DE); Karl Griessbaum, Muehlenbach (DE)

Correspondence Address: FAY KAPLUN & MARCIN, LLP, 15O BROADWAY, SUITE 702, NEW YORK, NY, 10038, US

(21) Appl. No.: 11/687,933

(22) Filed: Mar. 19, 2007

Related U.S. Application Data
(60) Provisional application No. 60/786,605, filed on Mar. 27, 2006.

(30) Foreign Application Priority Data
Mar. 27, 2006 (DE) DE102006 014010.9

(51) Int. Cl. G01S 13/08

(52) U.S. Cl. 342/124; 342/175

(57) ABSTRACT

Described is a wave guide adapter for a filling level radar. The adapter includes a decoupling member for reducing a leakage signal from a first line to a second line. The decoupling member is electrically isolated from the lines. Reducing the leakage signal increases the sensor's sensitivity at close range.

### REFERENCE TO RELATED APPLICATIONS

This application claims the benefit of the filing date of German Patent Application Serial No. 10 2006 014 010.9 filed Mar. 27, 2006 and U.S. Provisional Patent Application Ser. No. 60/786,605 filed Mar. 27, 2006, the disclosure of each of the above applications is hereby incorporated herein by reference.

### FIELD OF THE INVENTION

The present invention concerns level measuring. In particular, the present invention relates to a wave guide adapter for a filling level radar, a microwave module for a filling level radar with a wave guide adapter, a filling level radar for determining a filling level in a tank, and the use of such a wave guide adapter for level measuring.

### BACKGROUND INFORMATION

In addition to an antenna for sending or receiving radar waves, known level measuring instruments may have a coupling, which is made for coupling the electromagnetic waves generated inside the level measuring instrument into a wave guide or for decoupling the receiving signal from the wave guide.

From DE 100 23 497, a coupling is known, which couples electromagnetic waves from a planar line structure, such as a microstrip line, into a wave guide, with one terminal of the line protruding into the wave guide.

If it is desired to work with two polarization planes, two line terminals may be used, which protrude into the wave guide at a given angle. As due to their length, both terminals may get relatively close together inside the wave guide, decoupling between both connections of the wave guide adapters is relatively low.

This is due e.g. to overlapping stray fields at the line terminals. Due to such insufficient decoupling, the transmit signal applied to both connections may thus e.g. be irradiated unintentionally in both polarization planes within the wave guide.

In addition, it may happen that when both connections are used for generating circular polarization, a large leakage signal appears at the wave guide coupling. For generating circular polarization, both connections are e.g. driven with a 90° phase shift. If, in this case, the reflection loss or isolation between both couplings is too low, as mentioned before, a large leakage signal may appear at the wave guide coupling of the filling level radar sensor, which signal goes directly from the emitter to the receiver. This leakage signal may contribute to an increase of the so-called “Klingeln”, which is a repeated reflection between microwave module and coupling, so that the measuring sensitivity at close range may drop severely.

In WO 2004/097347, further devices for generating circular polarized waves are described, which may also be used in the filling level radar above. Again, the measuring sensitivity obtained may not be optimal.

### SUMMARY OF THE INVENTION

According to a sample embodiment of the present invention, a wave guide adapter for a filling level radar is proposed, the wave guide adapter comprising a first line and a second line, both for coupling an electromagnetic transmit signal into a wave guide, and a decoupling member for reducing overcoupling or a leakage signal from the first line to the second line, wherein the decoupling member is isolated from the first line and the second line.

By providing a decoupling member, the normally created large leakage signal, which is created by overcoupling from one line terminal to the other, may be reduced significantly. Due to the substantially smaller leakage signal, sensitivity may be increased, in particular also at the sensor's close range.

In addition, multiple reflections may be reduced so that fewer interference patterns appear. This may lead to an additional enhancement of the sensor's accuracy at close range.

According to another sample embodiment of the present invention, the wave guide adapter comprises a wave guide connection for connecting a wave guide or an antenna.

Thereby, the wave guide adapter in the shape of a modular component may be fitted into a filling level radar, and then connected to a wave guide leading to an antenna, or directly to the antenna.

Herein, the wave guide connection is implemented so that the wave guide can be connected easily.

According to another sample embodiment of the present invention, the wave guide adapter comprises in addition a resonant cavity for terminating the wave guide connection.

The resonant cavity is implemented e.g. as a wave guide portion provided with a cover.

According to another sample embodiment of the present invention, the two lines protrude into the wave guide connection and/or the resonant cavity. Hence, it may be possible to obtain effective and relatively efficient coupling of the electromagnetic signals into the wave guide.

According to another sample embodiment of the present invention, the wave guide adapter is adapted for generating an electromagnetic transmit signal with two polarization planes, wherein the two lines have an angle of 90° to each other.

Thereby, circular polarized waves can be generated, wherein the inventive decoupling member may reduce leakage signals between the two lines.

According to another sample embodiment of the present invention, both the first terminal of the first line and the second terminal of the second line have an enlarged part or a narrowed part.

Thereby, the dissipation characteristic of the lines may be varied and optimized, depending on the application.

According to another sample embodiment of the present invention, the decoupling member is implemented as a conductive member having a square planar structure.

The decoupling member may be for instance a metal coating on a printed circuit board, which is generated photochemically by a board etching method. The conductive member may consist of various materials or alloys, and may e.g. also be vaporized, glued, printed, or applied otherwise.

According to another sample embodiment of the present invention, the decoupling member has an edge length of about λ/4. At a frequency of 26 GHz, this corresponds to an edge length of 2 to 3 mm.

According to another sample embodiment of the present invention, the decoupling member is made plane, e.g. in the shape of a square, a triangle, a rectangle, or another geometric figure. It may also be possible for the decoupling member to have a recess, so as to form for instance an annulus or the outline of a square.

The lines, which are implemented for coupling the electromagnetic signals into the wave guide, may be implemented as a microstrip.

The entire decoupling member, possibly together with the lines, may be configured integrally in a board manufacturing process. Thereby, production costs may largely be minimized.

According to another sample embodiment of the present invention, the wave guide adapter is adapted for coupling the electromagnetic transmit signal at a frequency between 6 GHz and 100 GHz in the wave guide. E.g., the wave guide adapter is optimized for a frequency of 6.3 GHz, or for a frequency of 26 GHz, or for a frequency range between 77 GHz and 80 GHz.

Of course, the wave guide adapter may also be implemented for higher frequencies, or else for lower frequencies.

According to another sample embodiment of the present invention, a microwave module for a filling level radar is proposed, having a wave guide adapter as described above.

Such a microwave module may be fitted into a filling level radar together with the wave guide adapter as a modular component. Thereby, maintenance costs may be reduced, as the microwave module may be replaced as a global component without any problem.

According to another sample embodiment of the present invention, a filling level radar for determining a filling level in a tank is proposed, the filling level radar comprising an antenna for sending and/or receiving electromagnetic waves, and a wave guide adapter, as described above.

In addition, the use of an inventive wave guide adapter for level measuring is proposed.

Other sample embodiments and advantages of the invention result from the subclaims.

Below, with reference to the figures, sample embodiments of the present invention will be described.

### BRIEF DESCRIPTION OF THE FIGURES

FIG. 1 shows a functional diagram of a microwave module for a filling level radar according to an exemplary embodiment of the present invention.

FIG. 2 shows a schematic representation of an arrangement of a printed circuit board inserted into the wave guide with two orthogonal polarization planes.

FIG. 3 shows the arrangement of FIG. 2, as seen from the bottom.

FIG. 4 shows the arrangement of FIG. 2 without resonant cavity termination.

FIG. 5 shows a schematic representation of an electric field with an excitation at connection 106.

FIG. 6 shows a schematic representation of reflection attenuation, transfer function, and isolation between both connections.

FIG. 7 shows a schematic representation of a device for decoupling two receiving signals in a satellite LNC.

FIG. 8 shows a wave guide adapter for a filling level radar according to a sample embodiment of the present invention.

FIG. 9 shows a schematic representation of the electric field with an excitation at the connection 106 of the wave guide adapter of FIG. 8.

FIG. 10 shows a schematic representation of the course of the reflection attenuation, transfer function, and isolation between the two connections of the wave guide adapter of FIG. 8.

FIG. 11 shows a functional diagram of a microwave module according to a sample embodiment of the present invention.

FIG. 12 shows a schematic representation of a filling level radar according to a sample embodiment of the present invention.

The representations in the figures are schematic and not to scale.

In the following description of the figures, the same reference numerals are used for identical or similar elements.

### DETAILED DESCRIPTION

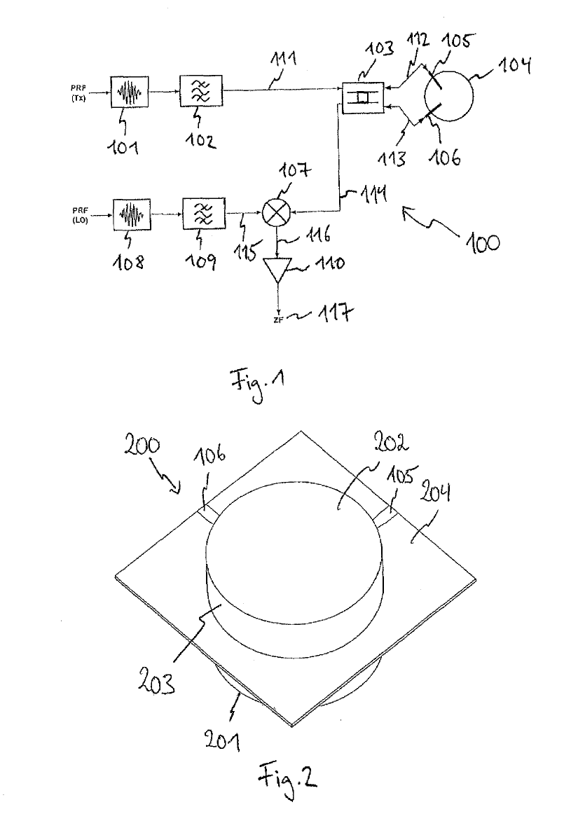

FIG. 1 shows a schematic representation of a functional diagram of a microwave module. The microwave module 100 has a transmit pulse oscillator (Tx oscillator) 101. The electromagnetic signal generated therein is transmitted via a band-pass filter 102 to a transmit coupler 103.

The transmit coupler 103 is implemented e.g. as a symmetrical or asymmetrical hybrid coupler. The Signal 111 goes through the transmit coupler 103 with relatively low attenuation, and is transmitted as a signal 112 to a first line 105. The first line 105 is implemented for coupling the electromagnetic signal 112 into a wave guide 104.

In addition, the hybrid coupler 103 is linked to a second line 106, over which a second electromagnetic signal 113 can be coupled into the wave guide 104. The second electromagnetic signal 113 is herein phase shifted e.g. by 90° from the first electromagnetic signal 112. By a symmetrical hybrid coupler, an even amplitude distribution of the transmit signal over the two signals 112 and 113 may be obtained. These two signals differ by 90° in phase, due to different running times in the hybrid coupler. Thereby, a circular polarized wave is obtained in the round wave guide 104.

The wave guide 104 is linked to an antenna system (not represented in FIG. 1), by which a measuring pulse can be emitted, which is then reflected by the object to be measured or the medium to be measured (which is for instance a filling material surface) as a receiving signal. The receiving signal is subsequently picked up again by the antenna system and transmitted to the transmit coupler 103.

As a simple reflection at the filling material surface modifies the direction of rotation of the wave, e.g. from left-handed to right-handed, the two signals received 112 and 113 are composed in the transmit coupler into one signal 114 and transmitted to the sampling mixer 107.

The receiver circuit 107 to 110 has a pulse generator 108 and a band-pass filter 109, which output a signal 115 to a sampling mixer 107. In the sampling mixer 107, the signal 115 samples the receiving signal 114, and generates thereby a frequency stepped-down signal 116, which is subsequently amplified by the amplifier 110, and is available at the IF output 117 as an IF signal for filling level evaluation and determination.

As the two lines 105, 106, due to their length, get relatively close together inside the wave guide 104, decoupling between the two connections of the wave guide adapters may be relatively low. This is due to the stray fields at the line terminals, which overlap. Due to this lack of decoupling, e.g. the transmit signal applied to one of the two connections 105, 106 may be radiated unintentionally in both polarization planes within the wave guide 104.

In addition, in particular when generating a circular polarization, due to high overcoupling from the first to the second line terminal, a large leakage signal may appear, which may lead to multiple reflections between transmitter, antenna, and receiver, so that the measuring sensitivity at close range may drop severely.

FIG. 2 shows a schematic representation of a printed circuit board inserted into the wave guide 201, 203 with two orthogonal polarization planes. At the connections 105, 106, e.g. microwave sources or the receiver are/is connected. On the upper side of the printed circuit board 204, the wave guide 201 is terminated by a resonant cavity 202, 203.

FIG. 3 shows the arrangement of FIG. 2 viewed from the bottom with the wave guide connection 201. Herein, the wave guide connection 201 is implemented so that it can be connected to a corresponding wave guide, so that the coupled electromagnetic signals may be transmitted in the connected wave guide.

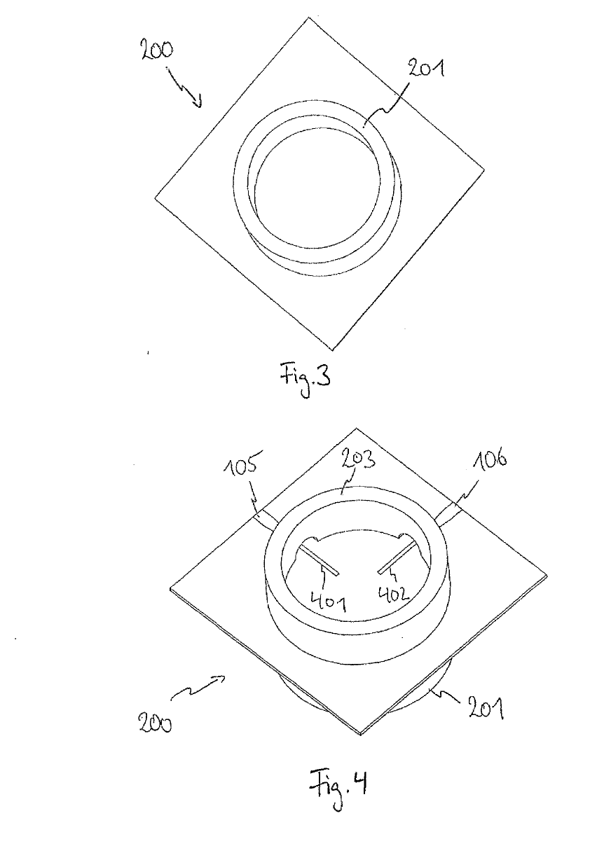

FIG. 4 shows a schematic representation of the internal construction of the arrangement represented in FIGS. 2 and 3. The line terminals of the lines 105, 106 protrude as radiating members into the wave guide 201 and the resonant cavity 203. Herein, the terminals protruding into the wave guide/resonant cavity 201, 203 may have an enlarged part, or else as represented, a narrowed part.

The radiated signal at the line terminal 401 originating at connection 105 is now received at the line terminal 402 originating at connection 106, and tapped at connection 106 as an undesirable leakage signal.

FIG. 5 shows a schematic representation of an electric field course with an excitation or impulse at connection 106. At the terminal of the line 106 protruding into the wave guide, it can be seen clearly how the field also propagates towards the connection 105 (or the terminal 401 thereof).

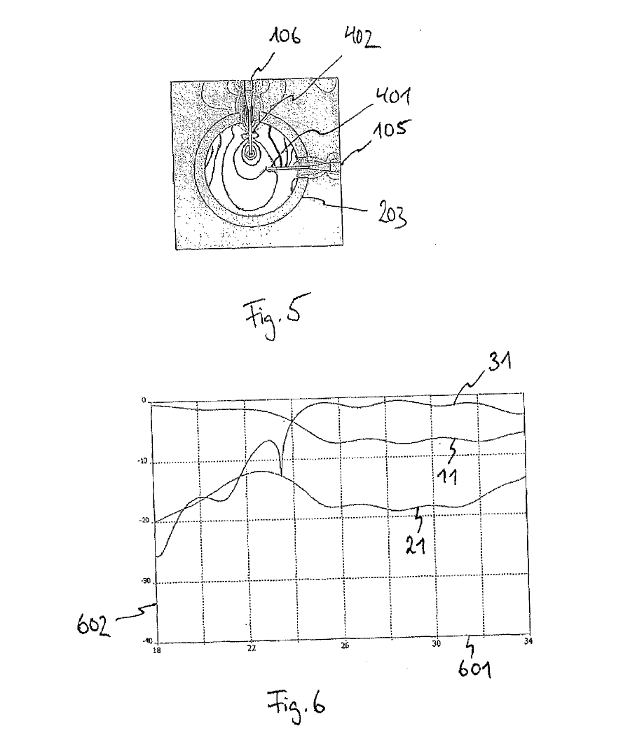

FIG. 6 shows a schematic representation of the course of the reflection loss 11 at connection 105, the transfer function from connection 105 to the wave guide terminal 401 (reference numeral 31) and the isolation 21 between connection 105 and connection 106.

The horizontal axis 601 reproduces the frequency, and ranges from 18 GHz to 34 GHz. The vertical axis 602 reproduces attenuation, and ranges from 0 dB to −40 dB.

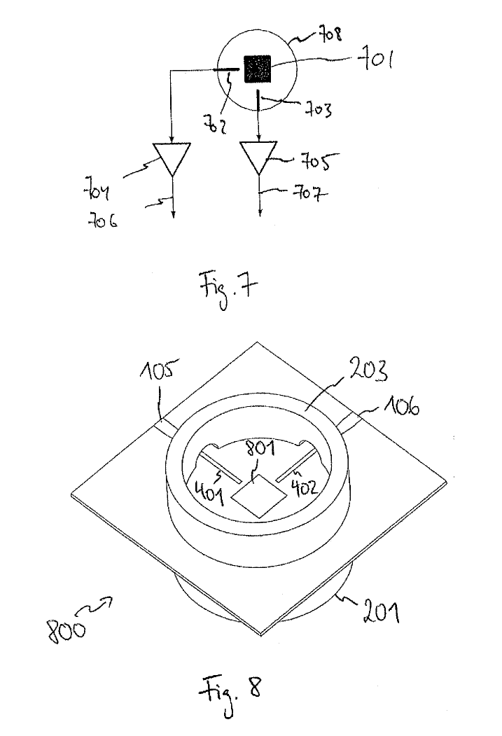

FIG. 7 shows a schematic representation of a satellite LNC, with lines 702, 703 for decoupling the receiving signal from the wave guide 708. For decoupling the two polarization planes, a resonator 701 is provided between the two line terminals 702, 703 protruding into the wave guide 708. The two receiving signals are subsequently amplified in the corresponding amplifiers 704, 705 and transmitted as horizontal polarization signals 706 or vertical polarization signals 707.

The satellite LNC represented in FIG. 7 is not implemented for coupling the electromagnetic signals of the lines 702, 703 into the wave guide 708.

FIG. 8 shows a schematic representation of a decoupling member, which is integrated into an inventive wave guide adapter 800. Herein, it has to be noted that the back cover 202, which serves as the termination of the resonant cavity, has been omitted for the sake of improved representation.

The decoupling member 801 is applied in the middle of the wave guide 201, 203 as a square-shaped planar structure, which has however no conductive link with the line terminals 401, 402 protruding into the wave guide 201, 203. The edge length is e.g. about λ/4. At an operating frequency of 26 GHz, the edge length thus ranges between 2 and 3 mm. At higher frequencies or lower frequencies, correspondingly smaller or larger edge lengths may result.

Due to the inventive decoupling member 801, the stray field around line terminal 401 or 402 may reduce towards the other line terminal, respectively, and thus, a substantially weaker coupling may result between the two polarization planes. Thus, the normally relatively large leakage signal, which occurs due to overcoupling from one line terminal to another, may be reduced significantly. Due to this substantially smaller leakage signal, the sensitivity at the sensor's close range may increase. In addition, the electric field may be substantially more effective even at the line terminals, which may also improve the reflection loss and the transmission loss.

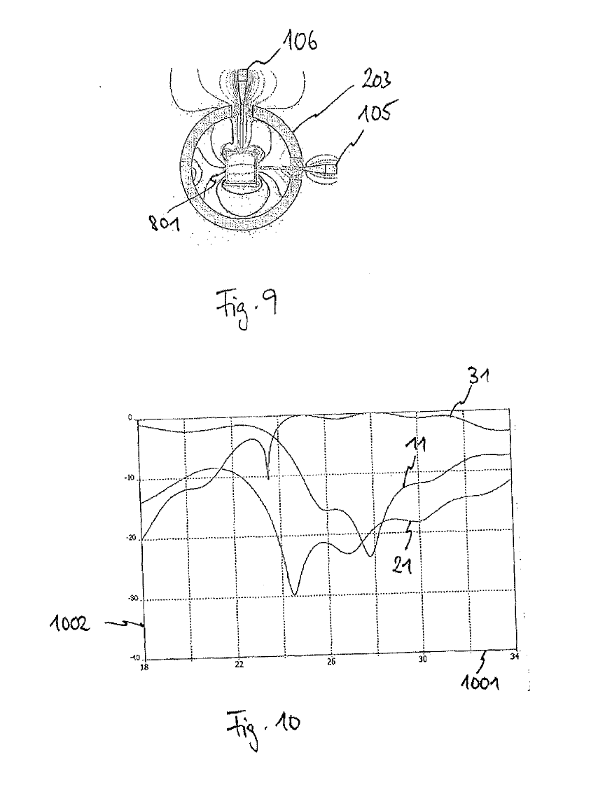

FIG. 9 shows a schematic representation of the course of the electromagnetic field. As can be seen in FIG. 9, the resulting electromagnetic field is shaped substantially more evenly at the coupling, which may have a positive effect on the transmission quality of the wave guide adapter.

FIG. 10 shows schematically the course of the reflection loss 11 at the connection 105, the transfer function of the connection 105 to the wave guide terminal 401 (reference numeral 31) and the isolation 21 between connection 105 and connection 106.

Herein, the horizontal axis 1001 stands for frequency, and ranges from 18 GHz to 34 GHz. The vertical axis 1002 stands for attenuation in decibels (dB), and ranges from 0 dB to 40 dB.

The table 1 represented below opposes the results of the previous simple couplings and of couplings with a decoupling member according to a sample embodiment of the present invention in the frequency range between 25 GHz and 27 GHz. As can be seen from table 1, clearly improved decoupling may result, and substantially better reflection loss at the connection 105. The values represented in table 1 are simulated.

TABLE 1

| | without | | with | |
|---|---|---|---|---|
| | decoupling member | | decoupling member | |
| reflection attenuation 11 | 7 . . . 8 | dB | 15 . . . 20 | dB |
| isolation attenuation 21 | 15 . . . 28 | dB | 22 . . . 28 | dB |
| transmission attenuation 31 | 1.1 | dB | 0.6 | dB |

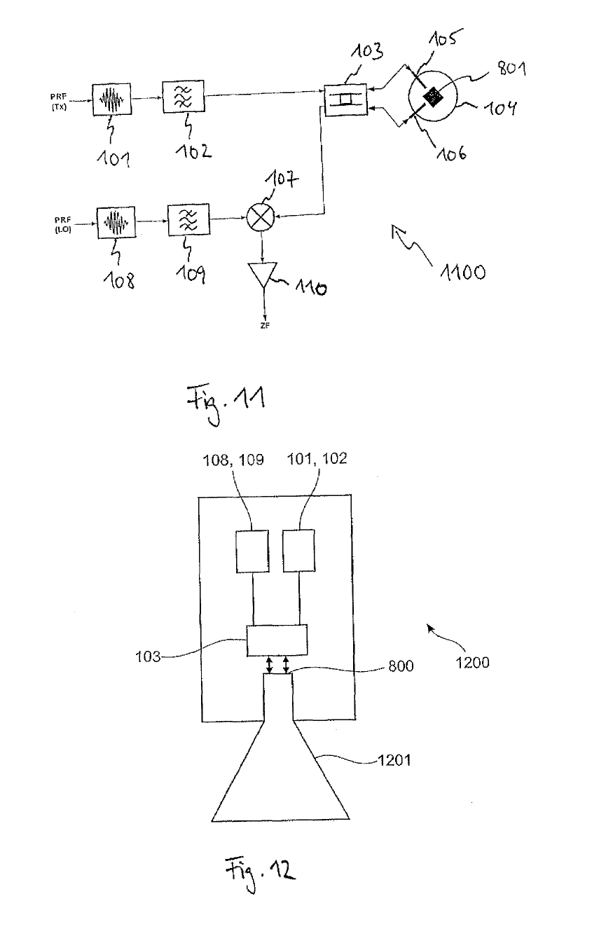

FIG. 11 shows a functional diagram of a microwave module 1100 for a filling level radar sensor with the adapter described above from a microstrip line to a wave guide according to a sample embodiment of the present invention. In addition to a transmitter unit 101, 102 and a receiver unit 107 to 110, the microwave module 1100 also has a hybrid coupler 103 and lines 105, 106, which are implemented for coupling the electromagnetic signals into the wave guide 104.

In addition, the inventive microwave module has a decoupling member 801, which may be made integrally in a board manufacturing process, and which is implemented for reducing a leakage signal from the first line 105 to the second line 106. Herein, the decoupling member 801 is electrically isolated from the first line 105 and the second line 106.

FIG. 12 shows a schematic representation of a filling level radar according to another sample embodiment of the present invention.

Herein, the filling level radar 1200 has a signal generator unit 101, 102, a transmit coupler 103 and a receiver circuit 107 to 110 (see FIG. 1). In addition, an antenna device 1201 with a circular wave guide coupling 800 is provided.

The implementation of the invention is not limited to the embodiments represented in the figures. Rather, a plurality of variants can be envisaged, which make use of the represented solution and the inventive concept, even in case of fundamentally different types of embodiments.

Additionally, it is to be noted that “comprising” does not exclude any other elements or steps, and that “a” or “an” do not exclude a plurality. Furthermore, it is to be noted that features or steps having been described with reference to one of the above sample embodiments may also be used in combination with other features or steps of other embodiments described above. Reference numerals in the claims are not to be construed as limitations.

What is claimed is:

1. A wave guide adapter for a filling level radar, comprising:
a first line and a second line coupling an electromagnetic transmit signal into a wave guide; and
a decoupling member reducing overcoupling from the first line to the second line,
wherein the decoupling member is isolated from the first line and the second line.

2. The wave guide adapter according to claim 1, further comprising:
a wave guide connection connecting a wave guide.

3. The wave guide adapter according to claim 1, further comprising:
a resonant cavity terminating the wave guide.

4. The wave guide adapter according to claim 1, wherein the first and second lines protrude into the wave guide and the resonant cavity.

5. The wave guide adapter according to claim 1, wherein the wave guide adapter is adapted for generating an electromagnetic transmit signal with two polarization planes; and wherein the first and second lines have an angle of 90 degrees to each other.

6. The wave guide adapter according to claim 1, wherein a first terminal of the first line and a second terminal of the second line respectively have an enlarged part or a narrowed part.

7. The wave guide adapter according to claim 1, wherein the decoupling member is implemented as a conductive member with a square-shaped planar structure.

8. The wave guide adapter according to claim 1, wherein the decoupling member has an edge length of about λ/4.

9. The wave guide adapter according to claim 1, wherein the decoupling member one of (i) is implemented to be plane and (ii) has a recess.

10. The wave guide adapter according to claim 1, wherein the first and second lines are implemented as a microstrip.

11. The wave guide adapter according to any claim 1, further comprising:
a board substrate,
wherein the decoupling member is made integrally in a board manufacturing process of the board substrate.

12. The wave guide adapter according to claim 1, wherein the wave guide adapter is adapted for coupling of the electromagnetic transmit signal at a frequency between 6 gigahertz and 100 gigahertz in the wave guide.

13. The wave guide adapter according to claim 1, wherein the wave guide adapter is adapted for coupling of the electromagnetic transmit signal at a particular frequency in the wave guide, the particular frequency being one of (i) at 6.3 gigahertz, (ii) at 26 gigahertz and (iii) between 77 gigahertz and 80 gigahertz.

14. A microwave module for a filling level radar, comprising:
a wave guide adapter including (i) a first line and a second line coupling an electromagnetic transmit signal into a wave guide; and (ii) a decoupling member reducing overcoupling from the first line to the second line,
wherein the decoupling member is isolated from the first line and the second line.

15. A filling level radar for determining a filling level in a tank, comprising:
an antenna for at least one of sending and receiving electromagnetic waves; and
a wave guide adapter including (i) a first line and a second line coupling an electromagnetic transmit signal into a wave guide; and (ii) a decoupling member reducing overcoupling from the first line to the second line, the decoupling member being isolated from the first line and the second line.

16. The use of a wave guide adapter according for level measuring, the wave guide adapter including (i) a first line and a second line coupling an electromagnetic transmit signal into a wave guide; and (ii) a decoupling member reducing overcoupling from the first line to the second line, wherein the decoupling member is isolated from the first line and the second line.
